(19) United States
(12) Patent Application Publication
(10) Pub. No.: US 2023/0105438 A1
(43) Pub. Date: Apr. 6, 2023

(54) COMPUTING DEVICE FOR PREDICTING DATA FOR TRANSISTOR MODELING, TRANSISTOR MODELING APPARATUS HAVING THE SAME, AND OPERATING METHOD THEREOF

(71) Applicant: Samsung Electronics Co., Ltd., Suwon-si (KR)

(72) Inventors: Seyoung Park, Hwaseong-si (KR); Gwangnae Gil, Yongin-si (KR); Sola Woo, Suwon-si (KR); Jonghyun Lee, Hwaseong-si (KR)

(21) Appl. No.: 17/732,412

(22) Filed: Apr. 28, 2022

(30) Foreign Application Priority Data
Oct. 6, 2021 (KR) 10-2021-0132565

(51) Int. Cl. G06F 30/367

(52) U.S. Cl. CPC G06F 30/367

(57) ABSTRACT

A method of operating a transistor modeling apparatus includes acquiring sample data corresponding to transistor modeling through a test device; performing machine learning on the sample data and first electrical test (ET) data of a transistor mass production stage; generating second ET data for the transistor modeling as a result of performing the machine learning; and setting a representative value for the transistor modeling among the second ET data.

### CROSS-REFERENCE TO RELATED APPLICATION(S)

This application claims benefit of priority to Korean Patent Application No. 10-2021-0132565 filed on Oct. 6, 2021, in the Korean Intellectual Property Office, the disclosure of which is incorporated herein by reference in its entirety.

### FIELD

The present disclosure relates to a computing device, a transistor modeling apparatus including the computing device, and a method of operating the transistor modeling apparatus.

### BACKGROUND

In general, characteristics of transistors constituting a circuit have been considered in designing semiconductor devices. A device model may be established to simulate such transistors. Transistor modeling can be performed by combining hundreds of model parameters with electrical test (ET) values from actual product samples, based on device physics theory. This may result in consistency issues with respect to representative values caused by process distribution or variation (which may be limited by the samples), increased turnaround time (TAT), and/or increased cost scrap caused by testing after transferring an actual object.

### SUMMARY

Example embodiments provide a computing device configured to predict data that may be used or required for transistor modeling through machine learning using mass electrical test (ET) data, a transistor modeling apparatus including the computing device, and a method of operating the transistor modeling apparatus.

According to an example embodiment, a method of operating a transistor modeling apparatus includes: acquiring sample data corresponding to transistor modeling through a test device; performing machine learning on the sample data and first electrical test (ET) data of a transistor mass production stage; generating second ET data for the transistor modeling as a result of performing the machine learning; setting a representative value for the transistor modeling among the second ET data, and performing the transistor modeling responsive to setting the representative value. The first ET data and the second ET data include at least one electrical parameter associated with transistor operation.

According to an example embodiment, a transistor modeling apparatus includes: a test device configured to perform an electrical test corresponding to transistor modeling on a wafer; and a computing device configured to perform machine learning on first electrical test (ET) data of a transistor mass production stage and third ET data measured from the test device based on a size of a transistor, to predict second ET data that is not measured from the test device based on the size of the transistor, using result values obtained by performing the machine learning, to construct the transistor modeling using the second ET data and the third ET data. Each of the first ETE data, the second ET data, and the third ET data includes at least one electrical parameter associated with transistor operation.

According to an example embodiment, a computing device includes: a processor configured to operate a transistor modeling tool; and a memory configured to store computer program code of the transistor modeling tool and first electrical test (ET) data of a transistor mass production stage. The transistor modeling tool is configured to acquire third ET data measured from a wafer by a test device, perform machine learning on the first ET data and the third ET data, generate second ET data based on a result obtained by performing the machine learning, select a representative value for transistor modeling among the second ET data, and change the transistor modeling using the second ET data and the third ET data. Each of the first ET data, the second ET data, and third ET data includes at least one electrical parameter associated with transistor operation.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a schematic view illustrating a transistor modeling apparatus according to an example embodiment.

FIG. 2 is a schematic flowchart illustrating a method of operating a transistor modeling apparatus according to an example embodiment.

FIG. 3A is a view illustrating an operation of securing sampling data according to an example embodiment, FIG. 3B is a view illustrating an operation of performing machine learning according to an example embodiment, and FIG. 3C is a view illustrating an operation of generating ET data that may be used or required for modeling according to an example embodiment.

FIG. 4 is a view illustrating measured ET data according to an example embodiment.

FIG. 5 is a flowchart illustrating a method of modifying a transistor model using a transistor modeling apparatus according to an example embodiment.

FIG. 6 is a view illustrating a computing device according to an example embodiment.

### DETAILED DESCRIPTION

Hereinafter, example embodiments will be described with reference to the accompanying drawings.

A computing device, a transistor modeling apparatus including the computing device, and a method of operating the transistor modeling apparatus according to an example embodiment may replace measurement values (for example, 7ET), which may be required for transistor modeling, with result values of machine learning using a mass electrical test (ET) for testing a product. Thus, a computing device, a transistor modeling apparatus including the computing device, and a method of operating the transistor modeling apparatus may address product representativeness issues caused by distribution noise, issues of conventional methods of measuring a small amount of samples, and/or may reduce turnaround time (TAT) for setting transfer and test required for measurement.

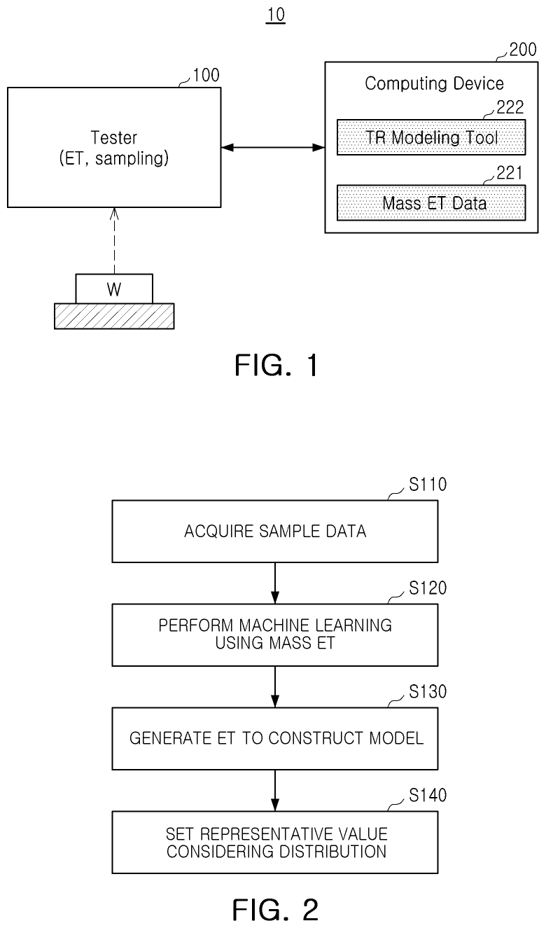

FIG. 1 is a schematic view illustrating a transistor modeling apparatus 10 according to an example embodiment. Referring to FIG. 1, the transistor modeling apparatus 10 may include a test device 100 and a computing device 200.

The test device 100 may be configured to perform an electrical test (ET) on a wafer W. The wafer W may include a plurality of semiconductor chips. The test device 100 may include a probe card for performing the ET. The test device 100 may perform a test in units of shots according to the probe card. The unit of shot may be a test area, in which a plurality of chips may be simultaneously tested, of the wafer W. In some embodiments, a shot region may vary according to the type of probe card.

In some embodiments, the test device 100 may perform an ET in respective predetermined positions in units of shots. In some embodiments, the number of the predetermined positions may be nine. However, it will be understood that the number of the predetermined positions is not limited thereto.

In some embodiments, the test device 100 may perform an ET on a test element group (TEG) between chips of a shot region. An electrical die sorting (EDS) process is a process in which, before packaging semiconductor chips, defective chips may be removed to save time and/or costs to package the defective semiconductor chips. The EDS process may include an ET process for measuring a TEG formed in a scribe line region and a process for determining a defect of a semiconductor chip formed on a semiconductor substrate. In detail, the TEG may be disposed in the scribe line to measure characteristics of electrical devices used for a semiconductor chip, for example, pure electrical devices such as a transistor, a resistor, a capacitor, a diode, and the like. Since the TEG is fabricated by a fabrication process under the same conditions, environment, and apparatus as the semiconductor chip formed on the semiconductor substrate, the TEG may be measured to detect characteristics of an electrical device of a semiconductor chip formed on a semiconductor substrate to be tested. For example, the ET may measure the TEG to calculate electrical characteristic data such as DC voltage and current characteristics for electrical devices that may be required to operate the semiconductor chip, and thus, may monitor a manufacturing process. Since the TEG is disposed on the scribe line in units of shots, criteria of a photolithography process, a single TEG may be disposed per a plurality of chips.

The computing device 200 may be configured to predict ET data (second ET data), which may be used or required for transistor modeling, using an ET measuring result (third ET data) of the test device 100 and mass ET data (first ET data) 221 of a mass production stage. The first ET data and the second ET data may include parameters of electrical DC voltage and current characteristics of individual devices (for example, a transistor, a resistor, a capacitor, a diode, and the like) that may be required to operate a semiconductor chip. In some embodiments, the computing device 200 may drive or execute a transistor modeling tool 222. The transistor modeling tool 222 may perform machine learning using the ET measuring result and the mass ET data 221 to predict an ET value that may be used or required for transistor modeling. The mass ET data 221 may be data generated in the EDS process.

In general, an EDS process may include electrical test and wafer burn-in (ET & WBI), hot/cold test, repair/final test, and inking processes. An electrical test (ET) may be a process of testing parameters of electrical DC voltage and current characteristics of individual devices (a transistor, a resistor, a capacitor, a diode, and the like), which may be used or required to operate a semiconductor integrated circuit, to determine whether the individual devices operate correctly (e.g., within desired specifications). In the wafer burn-in (WBI) process, a predetermined temperature may be applied to a wafer, and then an alternating current (AC) voltage and a direct current (DC) voltage may be applied thereto to detect potential defects such as product defects, vulnerable portions, and the like. The hot/cold test may be performed to determine whether there is a defective chip, among chips on the wafer, through electrical signals. Information may be stored to process a repairable chip in a repair process. In this case, tests at temperatures higher and lower than room temperature may be performed in parallel to determine whether a chip operates normally at a specific temperature. The repair test may be performed to repair chips, determined to be repairable in the hot/cold test, and to re-verify whether repaired chips are good or defective through a final test. The inking process may be performed such that data is processed to distinguishably identify defective chips. Such defective chips are not subjected to a packaging operation. A wafer, on which the inking process has been performed, may be baked, subjected to a quality control (QC) test, and then transferred to a packaging process.

An ET value that may be used or required for transistor modeling may be 7ET (VTE, Idsat, Idsat2, Idlin, Idmid, Idmid2, and Ioff).

In general, transistor modeling in semiconductor design can be performed by combining electrical test (ET) values with model parameters in actual product samples. Such a transistor modeling method results in consistency issues with respect to representative values caused by process distribution or process variation (which may be limited by the samples or sample size), increased turnaround time (TAT), and/or additional cost scrap due to testing after transferring an actual object.

Meanwhile, the transistor modeling apparatus 10 according to an example embodiment may perform machine learning using previously stored mass electrical test (ET) data to predict representative ET values (for example, 7ET) that may be used or required for modeling and a transistor model may be constructed using the predicted ET representative values. Accordingly, the transistor modeling apparatus 10 according to an example embodiment may address a representativeness issue of a product and may significantly reduce time for setting transfer and test that may be required for measurement.

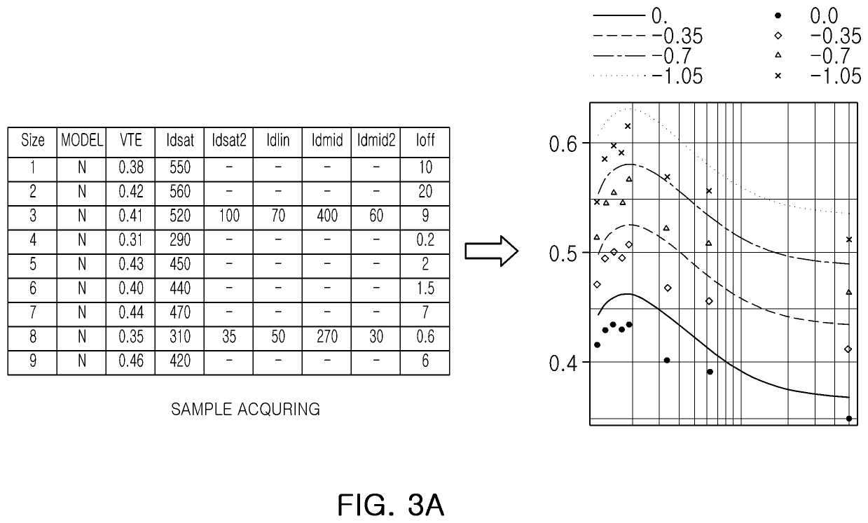

FIG. 2 is a schematic flowchart illustrating a method of operating a transistor modeling apparatus 10 according to an example embodiment. Referring to FIGS. 1 and 2, the transistor modeling apparatus 10 may operate, as follows.

In operation S110, the transistor modeling apparatus 10 may acquire sample data from the test device 100. In operation S120, the transistor modeling apparatus 10 may perform machine learning using mass ET data. The machine learning may be performed based on at least one of various algorithms such as a neural network, support vector machine (SVM), linear regression, a decision tree, a generalized linear model (GLM), random forest, gradient boosting machine (GBM), deep learning, clustering, anomaly detection, dimension reduction, and the like. The mass ET data may be acquired in the EDS process. In some embodiments, the mass ET data may be a value actually measured by the test device 100 or a value predicted from the computing device 200.

In operation S130, the transistor modeling apparatus 10 may generate ET data that may be used or required to construct a transistor model. In operation S140, the transistor modeling apparatus 10 may set a representative value in consideration of distribution of the generated ET data.

In some embodiments, the sample data may include various pieces of ET data according to or otherwise based on a size of a transistor (e.g., based on one or more physical dimensions of a transistor). In some embodiments, the ET data may include ET data that is not measured by the test device 100 according to a size of a transistor (e.g., data that is not attributed to transistor size). In some embodiments, the ET data may include a value of at least one of a threshold voltage, saturation current, linear region current, or off-leakage current.

In some embodiments, a determination may be further made as to whether a change in transistor modeling is required. In some embodiments, when a change in transistor modeling is required, target quantity may be sampled. In some embodiments, ET data may be measured from the sampled (e.g., target) quantity. In some embodiments, machine learning may be performed on the measured ET data and the mass ET data in a mass production stage to generate ET data (e.g., to predict ET data). In some embodiments, a representative value may be selected from the ET data (e.g., the predicted ET data) in consideration of mass production distribution (which may include data resulting from process variations). In some embodiments, the transistor modeling may be changed using the representative value. In some embodiments, the mass ET data may include ET data measured from the test device 100 and ET data predicted by a machine learning technique.

In a transistor modeling method according to an example embodiment, a representative value of ET data that may be used or required for transistor modeling may be set by performing machine learning using mass ET data and sampled ET data.

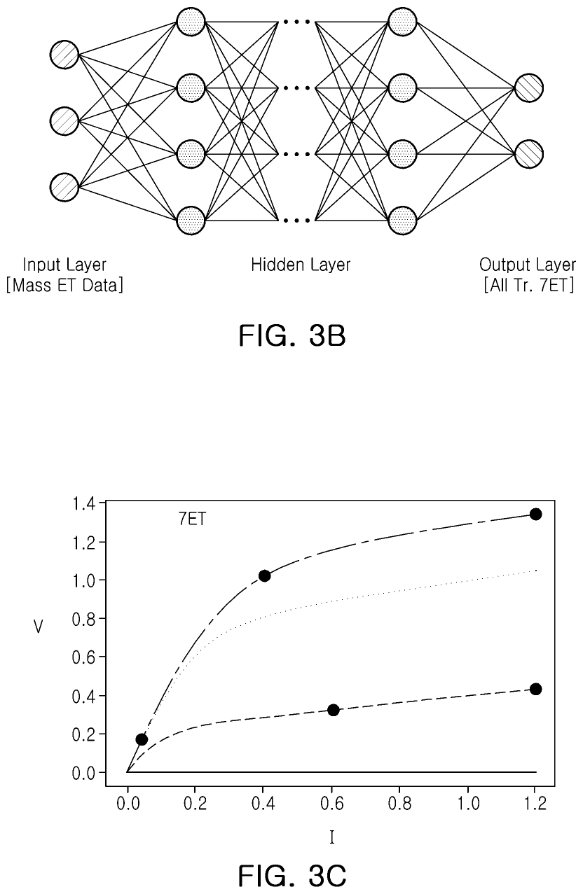

FIG. 3A is a view illustrating an operation of securing sampling data according to an example embodiment, FIG. 3B is a view illustrating an operation of performing machine learning according to an example embodiment, and FIG. 3C is a view illustrating an operation of generating ET data that may be used or required for modeling according to an example embodiment.

As illustrated in FIG. 3A, there may be ET data that is not measured according to a size of a transistor. For example, sample data may be acquired through the test device 100, but there may be ET data that is not measured according to a size of a transistor. If sufficient sample data is not present according to the size of the transistor, it may be difficult to set a current-voltage curve based on distribution or measurement noise during transistor modeling. As illustrated in FIG. 3B, some or all pieces of ET data based on the size of the transistor may be predicted by performing machine learning on insufficient sample data and mass ET data. As illustrated in FIG. 3C, distribution/measurement noise, which may not be confirmed from a relatively small amount of sample data, may be reduced by the machine learning performed on the ET data.

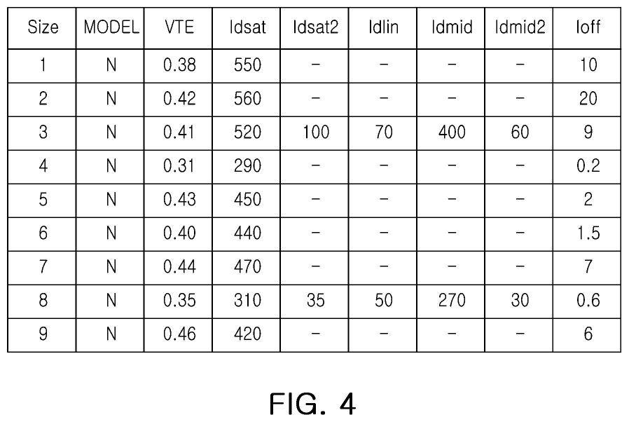

FIG. 4 is a view illustrating measured ET data according to an example embodiment.

Referring to FIG. 4, seven pieces of ET data (e.g., corresponding to various categories of electrical parameters or other device characteristics) according to sizes of nine transistors are illustrated. In FIG. 4, measured values illustrate actual measurement statuses of 7ET data for each size of an NMOS transistor.

In some embodiments, the 7ET measurement values may be values for a threshold voltage VTE, saturation current Idsat, saturation current Idsat2, linear region current Idlin, drain current Idmid, drain current Idmid2, and off-leakage current Ioff.

As illustrated in FIG. 4, ET data associated with a size of a third transistor and a size of an eighth transistor are all measured (i.e., respective data is obtained for each desired electrical parameter category). However, unmeasured values are present in ET data associated with sizes of the other transistors (as shown by the “-” notation in the table of FIG. 4).

The transistor modeling apparatus 10 according to an example embodiment may perform machine learning on mass ET data to predict or generate unmeasured ET data, and may use the predicted ET data with one or more measured values for transistor modeling (e.g., may perform the transistor modeling using the unmeasured or predicted ET data that was generated, in combination with the measured ET data).

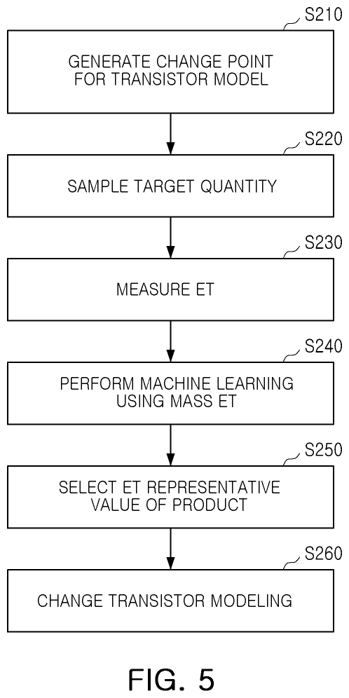

FIG. 5 is a flowchart illustrating a method of modifying a transistor model 10 using a transistor modeling apparatus according to an example embodiment. Referring to FIGS. 1 to 5, the transistor modeling apparatus 10 may operate, as follows.

In operation S210, the transistor modeling apparatus 10 may determine whether a change point for a transistor model has been generated. In operation S220, the transistor modeling apparatus 10 may perform sampling on target quantity when a change point is generated. In operation S230, an ET may be performed on a sampled chip. In operation S240, machine learning may be performed using the actually measured ET data (or third ET data) and the mass ET data (or the first ET data). As a result of performing the machine learning, ET data may be predicted and a representative value in the predicted ET data (or second ET data) may be selected in operation S250. In operation S260, transistor modeling may be changed using the selected ET representative value. The first ET data to the third ET data may include at least one electrical parameter associated with operation of the transistor.

In a transistor modeling method according to an example embodiment, a sample may be selected and measured when a device model according to a process change is modified, machine learning may be performed on mass ET data to predict ET data, and a representative value considering mass production distribution in the predicted ET data may be selected to modify a model more accurately and rapidly.

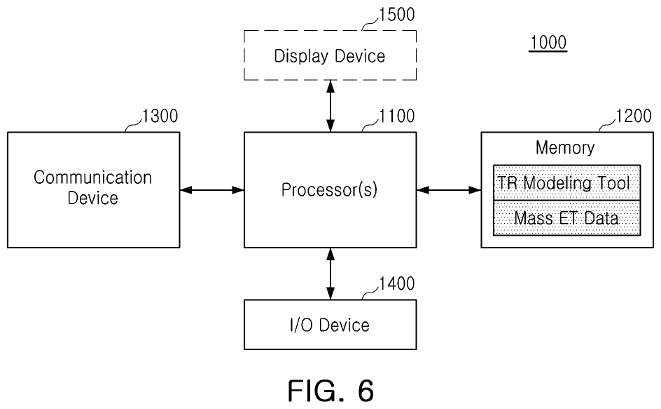

FIG. 6 is a view illustrating a computing device 1000 according to an example embodiment. Referring to FIG. 6, the computing device 1000 may include at least one processor 1100, a memory 1200, a communications device 1300, an input/output device 1400, and a display device 1500.

The processor 1100 may be configured to execute at least one instruction (or program) for performing the transistor modeling described in FIGS. 1 to 5. The processor 1100 may execute an instruction, and may control the computing device 1000. The processor 1100 may operate the transistor modeling tool (e.g., 222).

In some embodiments, the at least one instruction may be executed by at least one processor 1100 such that machine learning is performed using actually measured ET data and mass ET data to change the transistor modeling.

The computing device 1000 may be connected to an external device (for example, a personal computer or a network) through the input/output device 1400, and may exchange data.

The memory 1200 may be configured to store at least one instruction. The processor 1100 may perform the above-mentioned operations as at least one instruction stored in the memory 1200 is executed by the at least one processor 1100. In some embodiments, the memory 1200 may store mass ET data and a transistor modeling tool (e.g., computer program code of or defining the transistor modeling tool).

The memory 1200 may be a volatile memory or a nonvolatile memory. The memory 1200 may include a storage device to store user data. The storage device may be an embedded multimedia card (eMMC), a solid state drive (SSD), or a universal flash storage (UFS). The storage device may include at least one nonvolatile memory device. The nonvolatile memory device may be a NAND flash memory, a vertical NAND flash memory (VNAND), a NOR flash memory, a resistive random access memory (RRAIVI), a phase-change memory (PRAM), a magnetoresistive random access memory (MRAM), a ferroelectric random access memory (FRAM), a spin transfer torque random access memory (STT-RAM), or the like.

The communications device 1300 may be configured to communicate with an external network through various wired/wireless methods. For example, the communications device 1300 may perform wireless fidelity (Wi-Fi), Wi-Fi Direct, Bluetooth, ultra wide band (UWB), or near field communication (NFC), universal serial bus (USB), or network communication such as high definition multimedia interface (HDMI), local area network (LAN), or the like.

The display device 1400 may be implemented as various types of display, such as a liquid crystal display (LCD), an organic light emitting diode (OLED) display, an active-matrix organic light-emitting diode (AM-OLED), a plasma display panel (PDP), and the like.

The embodiments described above may be implemented through hardware components, software components, and/or a combination thereof. For example, the apparatus, method and components described in the embodiments may be implemented using one or more general-purpose computers or special-purpose computers, for example, a processor, a controller, an arithmetic logic unit (ALU), a digital signal processor, a microcomputer, a field-programmable gate array (FPGA), a programmable logic unit (PLU), a microprocessor, or any other device capable of executing instructions and responding thereto. The processing device may run an operating system (OS) and one or more software applications executed on the OS. Also, the processing device may access, store, manipulate, process and create data in response to execution of the software. For ease of description, the processing device is described as a single device, but those having ordinary skill in the art will understand that the processing device may include multiple processing elements and/or multiple forms of processing elements. For example, the processing device may include multiple processors or a single processor and a single controller. Also, other processing configurations such as parallel processors may be available.

The software may include a computer program, code, instructions, or a combination thereof, and may configure a processing device to be operated as desired, or may independently or collectively instruct the processing device to be operated. The software and/or data may be permanently or temporarily embodied in a specific form of machines, components, physical equipment, virtual equipment, computer storage media or devices, or transmitted signal waves in order to be interpreted by a processing device or to provide instructions or data to the processing device. The software may be distributed across computer systems connected with each other via a network, and may be stored or run in a distributed manner. The software and data may be stored in one or more computer-readable storage media.

The method according to the embodiments may be implemented as program instructions executable by various computer devices, and may be recorded in tangible computer-readable storage media. The computer-readable storage media may individually or collectively include program instructions, data files, data structures, and the like. The program instructions recorded in the media may be specially designed and configured for the embodiment, or may be readily available and well known to computer software experts. Examples of tangible computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter or the like. The above-mentioned hardware device may be configured so as to operate as one or more software modules in order to perform the operations of the embodiment, and vice-versa.

According to example embodiments, data that may be used or required for device characteristic modeling may be predicted and provided by a deep learning training technique using existing mass ET data without additional measurements (e.g., without requiring additional samples or measurement operations).

Such modeling may be applied to processing and fabrication of a fin field effect transistor (FinFET) structure. Inputs to such modeling may be etching process parameters, flowable chemical vapor deposition (CVD) process parameters, chemical mechanical polishing (CMP) process parameters, oxide metrology outputs, TEM's, and yield results. Such modeling may be used to detect and address issues with an etching process, a flowable CVD process, and a CMP process. That is, while described herein with reference to specific electrical test (ET) data, it will be understood that the ET data and values used for the modeling operations may vary based on the device being fabricated, and may include data other than the example electrical parameters or categories specifically mentioned herein.

According to example embodiments, device characteristics may be predicted by only machine learning using mass produced ET data. According to example embodiments, sampling and measurement process may be replaced with machine learning for existing device characteristic models to reduce TAT and costs.

In the transistor modeling apparatus according to an example embodiment and the method of operating the same, an ET value that may be used or required for transistor modeling may be calculated from mass ET data using a deep learning technique. In some embodiments, a novel learning technique for improving predictive power due to development of artificial intelligence (AI) learning may be applied. In some embodiments, a high-consistency prediction technique may be available while enhancing advantages of ET test-less using integrated device modeling database. When consistency of a data generation technique using mass production ET data is improved to a reliable level, a confirmation may be made as to whether transistor characteristics are changed when checking basic evaluation quantity of a novel process other than device modeling.

In general, deep learning, a type of AI learning, is being actively studied in design and development stages. The transistor modeling technique according to an example embodiment may have a technical characteristic in which the more data required for learning, the higher consistency. Accordingly, when data of the mass production stage with the largest amount of data is used, higher consistency may be expected to be achieved. In the transistor modeling technique according to an example embodiment, ET data that may be used or required for deep learning may be generated from mass ET data, measured to test product quality, using deep learning training to supplement a dataset configuration through existing sample measurements.

According to the computing device, the transistor modeling apparatus including the computing device, and the method of operating the transistor modeling apparatus described above, machine learning may be performed on a small amount of measured ET data and mass ET data in a mass production stage. Thus, ET data that may be used or required for transistor modeling may be rapidly and accurately predicted.

While example embodiments have been shown and described above, it will be apparent to those skilled in the art that modifications and variations could be made without departing from the scope of the present inventive concept as defined by the following claims.

What is claimed is:

1. A method of operating a transistor modeling apparatus, the method comprising:
acquiring sample data corresponding to transistor modeling from a test device;
performing machine learning on the sample data and first electrical test (ET) data of a transistor mass production stage;
generating second ET data for the transistor modeling as a result of performing the machine learning;
setting a representative value for the transistor modeling among the second ET data; and
performing the transistor modeling responsive to setting the representative value,
wherein the first ET data and the second ET data include at least one electrical parameter associated with transistor operation.

2. The method of claim 1, wherein the sample data includes various categories of ET data based on a size of a transistor.

3. The method of claim 1, wherein the second ET data includes ET data, which is not measured by the test device, based on a size of a transistor.

4. The method of claim 1, wherein each of the first ET data and the second ET data includes a value of at least one of a threshold voltage, saturation current, linear region current, or off-leakage current.

5. The method of claim 1, further comprising:
determining that the transistor modeling should be changed; and
changing the transistor modeling responsive to the determining.

6. The method of claim 5, wherein the acquiring the sample data comprises:
sampling a target quantity responsive to determining that the transistor modeling should be changed; and
measuring third ET data from the target quantity that was sampled.

7. The method of claim 6, wherein the performing the machine learning comprises performing the machine learning on the third ET data, and wherein the generating the second ET data is based on the performing the machine learning on the first ET data and the third ET data.

8. The method of claim 1, wherein the setting the representative value comprises:
selecting the representative value of the second ET data based on transistor mass production distribution.

9. The method of claim 1, further comprising:
changing the transistor modeling using the representative value.

10. The method of claim 1, wherein the first ET data includes measured ET data from the test device and predicted ET data from a machine learning technique.

11. A transistor modeling apparatus comprising:
a test device configured to perform an electrical test corresponding to transistor modeling on a wafer; and
a computing device configured to perform machine learning on first electrical test (ET) data of a transistor mass production stage and third ET data measured from the test device based on a size of a transistor, to predict second ET data that is not measured from the test device based on the size of the transistor using result values obtained by performing the machine learning, and to construct the transistor modeling using the second ET data and the third ET data,
wherein each of the first ET data, the second ET data, and the third ET data includes at least one electrical parameter associated with transistor operation.

12. The transistor modeling apparatus of claim 11, wherein each of the first ET data, the second ET data, and the third ET data includes values corresponding to a threshold voltage, saturation current, and off-leakage current, respectively corresponding to sizes of a plurality of transistors.

13. The transistor modeling apparatus of claim 11, wherein representative values are selected from the second ET data by a transistor modeling tool based on transistor process distribution or measurement noise.

14. The transistor modeling apparatus of claim 13, wherein the computing device is configured to change the transistor modeling using the representative values.

15. The transistor modeling apparatus of claim 11, wherein the third ET data includes values measured from a test element group (TEG) corresponding to at least one predetermined shot region of the wafer.

16. A computing device comprising:
a processor configured to operate a transistor modeling tool; and
a memory configured to store computer program code of the transistor modeling tool and first electrical test (ET) data of a transistor mass production stage,
wherein the transistor modeling tool is configured to acquire third ET data measured from a wafer by a test device, perform machine learning on the first ET data and the third ET data, generate second ET data based on a result obtained by performing the machine learning, select a representative value for transistor modeling among the second ET data, and change the transistor modeling using the second ET data and the third ET data, and
wherein each of the first ET data, the second ET data, and the third ET data includes at least one electrical parameter associated with transistor operation.

17. The computing device of claim 16, wherein the transistor modeling tool is configured to determine values corresponding to a threshold voltage, saturation current, linear region current, and off-leakage current based on a size of a transistor.

18. The computing device of claim 16, wherein the transistor modeling tool is configured to output a prediction trend that indicates transistor process distribution or measurement noise through the machine learning.

19. The computing device of claim 16, wherein the transistor modeling tool is configured to set a representative value for a threshold voltage, saturation current, linear region current, or off-leakage current based on a size of a transistor.

20. The computing device of claim 16, wherein the transistor modeling tool is configured to perform the machine learning to generate data, which is not generated based on a size of a transistor, as the second ET data.
